(19) United States
(12) Patent Application Publication
(10) Pub. No.: US 2004/0015307 A1
(43) Pub. Date: Jan. 22, 2004

(54) Method for a phase angle correction during scanning of a code track

(76) Inventor: David Heisenberg, Gerlingen (DE)

Correspondence Address: Striker Striker & Stenby, 103 East Neck Road, Huntington, NY, 11743, US

(21) Appl. No.: 10/362,116

(22) PCT Filed: Aug. 21, 2001
(86) PCT No.: PCT/DE01/03194

(30) Foreign Application Priority Data
Aug. 22, 2000 (DE) 100-41-092.8

(51) Int. Cl. G06F 19/00

(52) U.S. Cl. 702/72

(57) ABSTRACT

According to the invention, a method for correcting a phase angle when scanning a code track with sensor elements is proposed that delivers a sinusoidal and a cosinusoidal signal, with which the phase difference between two signals is corrected using a specified algorithm. Since the sensor elements used, e.g., GMR, AMR, or Hall sensor elements, deliver phase-displaced sinusoidal and cosinusoidal signals due to the arrangement of the code tracks, their phases must be corrected before the arctan of the quotient can be calculated. This takes place using an algorithm derived from an arc tangent function. The method according to the invention is used preferably to measure the rotational angle or torque of a steering shaft of a motor vehicle.

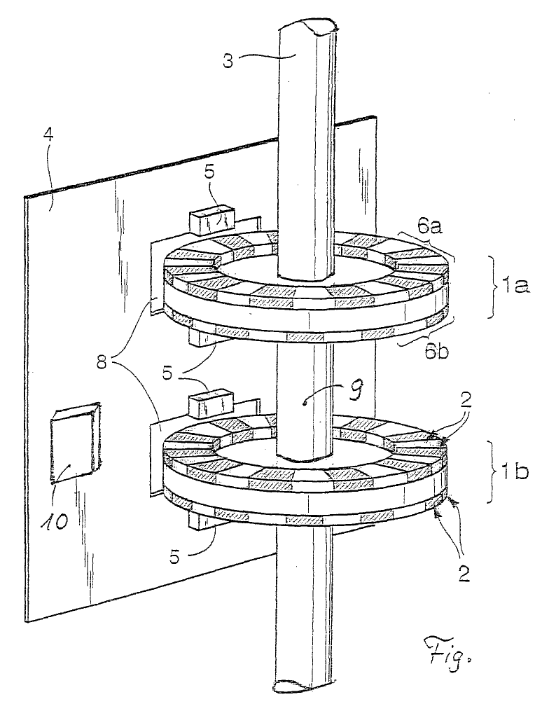

### BACKGROUND OF THE INVENTION

The invention is based on a method for correcting a phase angle of a code track according to the general class of the main claim. It is already known that magnetic code tracks can be scanned, e.g., using special magnetoresistive sensor elements, or that bar codes can be scanned using optical sensors. If this code track having a multitude of magnetic encodings in north and south poles is situated around a turnable shaft, the rotational angle can be detected using magnetoresistive sensor elements, and/or torque can be detected, given an appropriate design. An arrangement of this type is made known in the publication DE 198 18 799 C2. It is further known that GMR or AMR sensors (AMR=anisotropic magnetoresistance, GMR=giant magnetoresistance) can be used to measure a torsion angle on a steering shaft of a motor vehicle, for example. In the case of AMR sensors, two bridges that are offset with respect to one another are used that deliver a sinusoidal signal and a cosinusoidal signal when the multipole rings are scanned. The offset of the two bridges is equal to ¼ of the length of a pole pair. Additionally, Hall sensors are known that, offset accordingly, also deliver a sinusoidal and a cosinusoidal signal. Optical sensors, when connected accordingly, also deliver a sinusoidal and a cosinusoidal signal when a bar code is scanned. The arctan of the quotient of the sinusoidal and a cosinusoidal signal now delivers a periodic signal, the “sawtooth”. It has since been demonstrated that the sinusoidal and cosinusoidal signals are not measured exactly by 90° out of phase in relation to one another. This results in a nonlinear wave form of the sawtooth pattern and in periodic errors in the absolute angle and/or torque calculated based on said nonlinear wave form.

Deviations from a 90° phase angle can occur, e.g., when two similar sensor elements are used for two tracks having different pole lengths. For example, one sensor element measures a phase difference of 87.5°, and the other sensor element measures a phase difference of 90.5°.

### ADVANTAGES OF THE INVENTION

In contrast, the method according to the invention for correcting the phase angle when scanning a code track having the characterizing features of the main claim has the advantage that the phase error and/or the phase-angle error can be corrected using a specified algorithm. This advantageously prevents the need for costly structural measures to eliminate the phase error, as well as costly adaptations. A particular advantage is the fact that, by correcting the phase error, the measurement of the absolute angle is improved as well, so that, overall, greater accuracy can be obtained in the determination of a rotational angle and torque.

Advantageous further developments and improvements of the method described in the main claim are possible due to the measures listed in the dependent claims. Particularly advantageous is the fact that the phase error can be determined using a simple formula with an arctan function. This procedure can easily be carried out after the sine and cosine values are detected, e.g., by an evaluation unit.

When a torsion element is used that is placed in a suitable location between two code wheels, the improved angular determination makes it possible to determine a torsion angle on the shaft with greater accuracy. With very small torsion angles in particular, such as those that occur with a steering shaft of a motor vehicle, a small torsion angle can also be determined advantageously with great accuracy.

For the method, GMR, AMR or Hall sensors appear particularly suitable for scanning magnetic code tracks, and optical sensors appear particularly suitable for scanning optical encodings, e.g., bar codes, since these components function reliably and without wear, and they are inexpensive to obtain.

### SUMMARY OF THE DRAWINGS

An exemplary embodiment of the invention is shown in the drawing and explained in greater detail in the description. The figure shows a torque angle sensor (TAS) having two code wheels and a torsion element located between them, as used with a steering shaft of a motor vehicle, for example.

### DESCRIPTION OF THE PREFERRED EMBODIMENTS

The figure shows a shaft 3 on which two code wheels 1a, 1b are permanently located. A torsion element 9 is located between the two code wheels 1a, 1b, whereby the two code wheels 1a, 1b detect the rotation of the torsion element 9 when torque acts on the shaft 3. Each code wheel 1a, 1b has two code tracks 6a, 6b that are located around the shaft 3 in the manner of rings. Each code track essentially comprises markings 2 that are designed as north and south poles when magnetic encoding is involved. In an alternative exemplary embodiment, optical markings 2 can be used as well.

In order to perform the most accurate angle measurement possible using one of the known vernier methods, each code track 6a, 6b has different numbers of pole pairs. The differences between the two are minimal, preferably in terms of one pole pair. Magnetic field-measuring sensor elements 5—which can be GMR, AMR or Hall sensors, for example—are associated with each code track 6a, 6b. When the shaft 3 turns, they detect the magnetic fields of the code tracks 6a, 6b and deliver corresponding phase-displaced sine and cosine values to an available evaluation unit 10. The evaluation unit 10 preferably determines the rotational angle from the input data received. By subtracting the rotational angle of the two code wheels 1a, 1b, one obtains a differential angle that corresponds to the torsion angle of the torsion element 9 when acted upon by torque M. When the stiffness of the torsion element 9 is known, the torque can be determined.

There is a basic problem with one code wheel 1a, 1b, that is, due to the different number of markings 2 or pole pairs, for example, the sensor elements 5 deliver phase-displaced sinusoidal and cosinusoidal signals. The sinusoidal and cosinusoidal signals are detected when the sensor is calibrated and they are used to calculate the phase angle using a Fourier transform. The signals are corrected using the following method before the arctan is calculated.

It is assumed that the amplitudes of a sensor element are based on the equations

U₁=U₀·sin (x+y) and

U₂=U₀·cos (x),

whereby the voltages U₁ and U₂ are the voltages at the sensor element 5. x is the rotational angle n·φ of the scanned magnetic track in the range of 0 to n·360°, whereby n is the number of pole pairs or periods. y represents the phase error.

Based on these definitions, the phase error y and/or the phase angle φ can be calculated as follows:

$$\frac{{U}_{1}}{{U}_{2}} = \frac{sin χ \cdot cos γ + cos χsin γ}{cos χ} = tan χcos γ + sin γ$$

If it is assumed that cos y it not equal to 0, then the final equation can be solved for the phase angle φ:

$$ϕ = 1 / n arctan ( \frac{{U}_{1} - sin γ \cdot {U}_{2}}{{U}_{2} \cdot cos γ} )$$

The arctan 2 function can be used as an alternative. It is an expanded arctan function that has a value range of 0 to 360°.

What is claimed is:

1. A method for correcting a phase angle when scanning a code track (6a, 6b), whereby sensor elements (5) deliver sinusoidal and cosinusoidal signals with a relative phase-angle error (y),
wherein the correction of the phase-angle error (y) is carried out using a specified algorithm, whereby the specified algorithm contains an arctan function.

2. The method according to claim 1,
wherein the correction of the phase angle (φ) is carried out according to the following equation:
$$ϕ = 1 / n \cdot arctan ( \frac{{U}_{1} - sin γ \cdot {U}_{2}}{{U}_{2} \cdot cos γ} ) ,$$
whereby y is the phase error, U₁, U₂ are the sinusoidal and cosinusoidal voltages of the sensor element (5), and n is the number of periods.

3. The method according to claim 1 or 2,
wherein the algorithm comprises an expanded arctan2 function for an angular range up to 360°, whereby the phase angle (φ) is calculated according to the following formula:
$$ϕ = 1 / n \cdot arctan 2 ( \frac{{U}_{1} - sin γ \cdot {U}_{2}}{{U}_{2} \cdot cos γ} ) .$$

4. The method according to claims 1 through 3,
wherein the phase correction takes place when a rotational angle of a shaft (3) is determined.

5. The method according to one of the preceding claims,
wherein, in combination with a torsional element (9), a torsional angle at the shaft (3) is determined.

6. The method according to one of the preceding claims,
wherein the code track (6a, 6b) comprises alternately situated north and south poles, and
the sensor elements (5) are designed as GMR, AMR, or Hall elements and scan the magnetic north and south poles.

7. The method according to one of the preceding claims,
wherein, in the case of optical encodings (2) of the code track (6a, 6b), the sensor elements (5) contain photosensitive sensors.

8. The method according to one of the preceding claims,
wherein the angular determination is carried out at a steering shaft (3) of a motor vehicle.
